(19) United States
(12) Patent Application Publication
(10) Pub. No.: US 2007/0112909 A1
(43) Pub. Date: May 17, 2007

(54) Information processing apparatus and system

(76) Inventors: Hiroki Miyamoto, Fujisawa (JP); Masataka Okayama, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/598,662

(22) Filed: Nov. 14, 2006

(30) Foreign Application Priority Data
Nov. 14, 2005 (JP) 2005-328254

(51) Int. Cl. G06F 15/16

(52) U.S. Cl. 709/200

(57) ABSTRACT

An information processing apparatus, enabling to communicate with an external apparatus through a communication network, comprising: a memory portion, which is configure to memorize information relating to service therein, describing the service provided with the information processing apparatus and the external apparatus as constituent elements thereof; and an output portion, which is configure to output information relating to the service memorized within the memory portion and identification information for identifying the information processing apparatus, to the external apparatus, when the external apparatus is connected thereto, whereby noticing available service(s) to a user, which can be provided in cooperation with information appliances under environment of the present home network, immediately, when an information appliance joins into the home network.

The present invention claims priority from Japanese application JP2005-328254 filed on Nov. 14, 2005, the content of which is hereby incorporated by reference into this application.

### BACKGROUND OF THE INVENTION

The present invention relates to a technology for a plural number of information processing apparatuses to communicate data through a communication network.

In recent years, many of technologies are proposed for providing a service to a user, mutually in cooperation with a plural number of apparatuses with using a middle software, such as UPnP (Universal Plug and Play) and/or Jini (registered trademark of SunMicrosystem), etc. For example, with the UPnP AV architecture, it is possible to operate functions of a plural number of servers by means of one (1) piece of a client (see Non-Patent Document 1).

Also, in Japanese Patent Laying-Open No. 2004-213612 (2004) is disclosed a technology for downloading an application with using OSGi, for detecting that a new information apparatus or appliance is added to a home network, in which an application server (such as, a home server) is located, with utilizing the UPnP or the Jini, and thereby utilizing the new information appliance therein.

[Non-Patent Document 1] OSGi Alliance OSGi Technology [on line] [searched on Aug. 19, 2005] <http://www.osgi.org/osgi_technology/index.asp?section=2>; and

[Patent Document 1] Japanese Patent Laying-Open No. 2004-213612 (2004).

### SUMMARY OF THE INVENTION

However, although mention is made about processing in case when a device is newly connected, thereby to provide a new function/service with using that device, in the documents mentioned above, however it is specialized only to the function owned by the device itself; therefore, no conception is made bout a reality of the services, which can be created newly in combination with the existing device and the new device. For that reason, only insufficient study is made on the processing in the case where the plural number of information appliances provide various services in relation with each other.

Accordingly, with such the technology as is disclosed in the documents mentioned above, there is such a problem that, although useful service can be achieved, inherently, between the device that is connected newly and the device that has been connected until that time, but there is no means for the user to utilize it.

Also, when trying to execute the service, which can be achieved between the device connected newly and the device that has been connected until that time, within the framework of the documents mentioned above, it is necessity to install a new control protocol, every time when a new device is connected thereto, onto the respective apparatuses, which are connected to the home network or the like. This is ineffective and increases the costs thereof.

Then, according to the present invention, an object thereof is to provide an information processing apparatus and an information processing system, for making the service executable, which can be provided in cooperation with the device that is connected newly and the device that was already connected therewith, for example.

In details, for example, within the information processing apparatus enabling to communicate data through an external apparatus and a communication network, it is enough, while memorizing service information, which can be achieved by the constituent elements, such as, that information appliance and the external apparatus or appliance, within that information processing apparatus, to output that service information memorized and identification information (for example, an ID information) thereof, to the home server or the like, which controls or manages the home network generally. In more details, it is enough to construct it as is described in the claims now pending.

It is possible to provide an information processing apparatus and an information processing system, enabling easy execution of the service(s), which can be provided in cooperation with the device that is connected newly and the device that was already connected therewith.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a configuration view of a service management system, according to an embodiment of the present invention;

FIG. 2 is a hardware construction view of an information processing apparatus, according to the present embodiment;

FIG. 3 is a hardware construction view of a home server, according to the present embodiment;

FIG. 4 is a view for showing an example of the structures of a device configuration table, according to the present embodiment;

FIG. 5 is a view for showing an example of the structures of the device configuration table, when it is stored into a device configuration table storage portion within the home server, according to the present embodiment;

FIG. 6 is a view for showing an example of the structures of a device management table, according to the present embodiment;

FIG. 7 is a flowchart for showing steps when installing a device configuration table, according to the present embodiment;

FIG. 8 is a flowchart for showing steps when installing software, according to the present embodiment; and

FIG. 9 is a flowchart for showing steps when executing the software, according to the present embodiment.

### DETAILED DESCRIPTION OF THE INVENTION

Hereinafter, explanation will be made on the embodiments according to the present invention, while assuming that an element attached with the same mark or reference numeral has the same function.

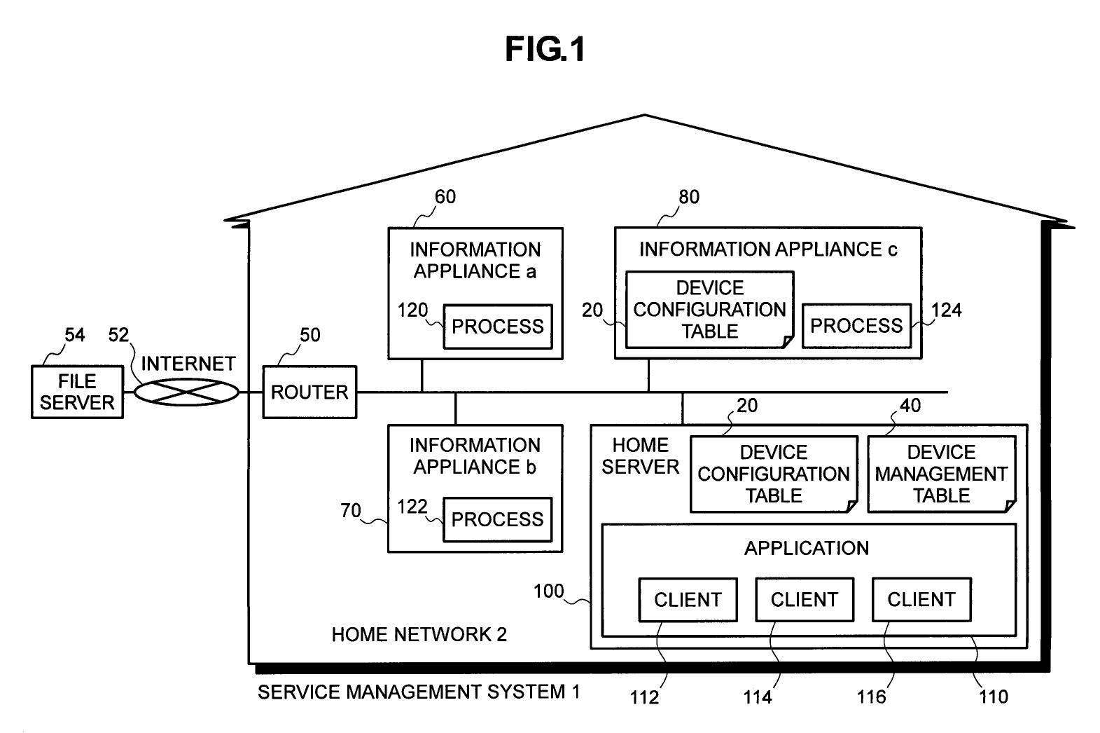

FIG. 1 is a view for showing an example of the system configuration of a service management system 1, according to the present invention. In this FIG. 1, a reference numeral 2 depicts a home network connecting information appliances within a home through a network, wherein a reference numeral 80 depicts an information appliance or device “c” having a device configuration table 20 therein, which newly enters into the home network, a reference numeral 60 depicts an information appliance or device “a”, which entered into the home network before the information appliance c 80 does, and a reference numeral 70 depicts an information appliance or device “b”, which also entered into the home network before the information appliance c 80 does, respectively. Further, a reference numeral 50 depicts a router for connecting between the home network inside the home and the network outside the home, 52 the Internet, 54 a file server having an application or the like, to be installed into the network apparatus(es) or device(s) inside the home, which is/are applicable with OSGi (Open Services Gateway Initiative) frame work, 100 a home server, 20 the device configuration table, 40 a device management table, 110 an application for controlling one (1) or plural numbers of client(s), and 112, 114 and 116 clients, wherein the clients 112, 114 and 116 are provided for the purpose of controlling processes 118, 120 and 122, which are provided in each of the information appliances or devices, and each of the processes 118, 120 and 122 has a function of executing a process requested from any one of the clients 112, 114 and 116, and returning a processing result to any one of the clients 112, 114 and 116, respectively.

With the information appliance(s) mentioned above, it/they is/are expressed by only “information appliance(s)”, in case when no distinction is made among the information appliance a 60, b 70, and c 80.

Also, in general, the information appliance indicates various kinds of information appliances for building up the home network, for example, a PC (i.e., personal computer), a HDD (i.e., a Hard Disk Drive) recorder, a DVD (i.e., Digital Versatile Disk) player, an air conditioner, a sensor, a NAS (i.e., Network Access Storage), an electric light or lamp, a refrigerator, an electronic or microwave oven, a clock, etc.

The home network 2 makes connection among the information appliances and devices, such as, the home PC, an AV apparatus, home electric appliances, etc., with using a wireless LAN (i.e., Local Area Network), a wired LAN, the Bluetooth, the UWB (Ultra Wide Band), and thereby enabling mutual communication of data between the information appliances themselves.

The device configuration table 20 is a table describing the information device information (i.e., the information appliance 22) therein, which are necessary for executing a higher-ranked service 21, in cooperation with functions 23 of providing basic services, which are provided by the plural numbers of information appliances with using the UPnP and/or Jini, etc.

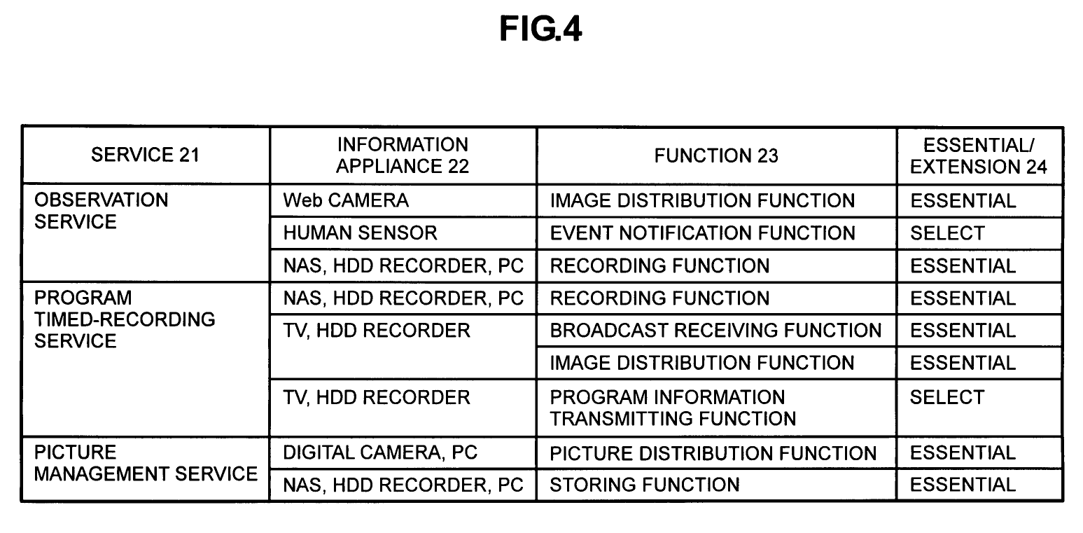

With the services, which are provided by the plural numbers of information appliances for a user, in cooperation therewith, a list of the services is described on the device configuration table 20, each being a constituent element of the information appliances having that device configuration table 20 mentioned above therein; therefore, it is possible to verify the services, which can be provided for the user, by comparing the function of the information appliance on the home network 2 to the device configuration table 20, as being so-called a design drawing of the services. The details of the device configuration table 20 will be mentioned, later, by referring to FIG. 4.

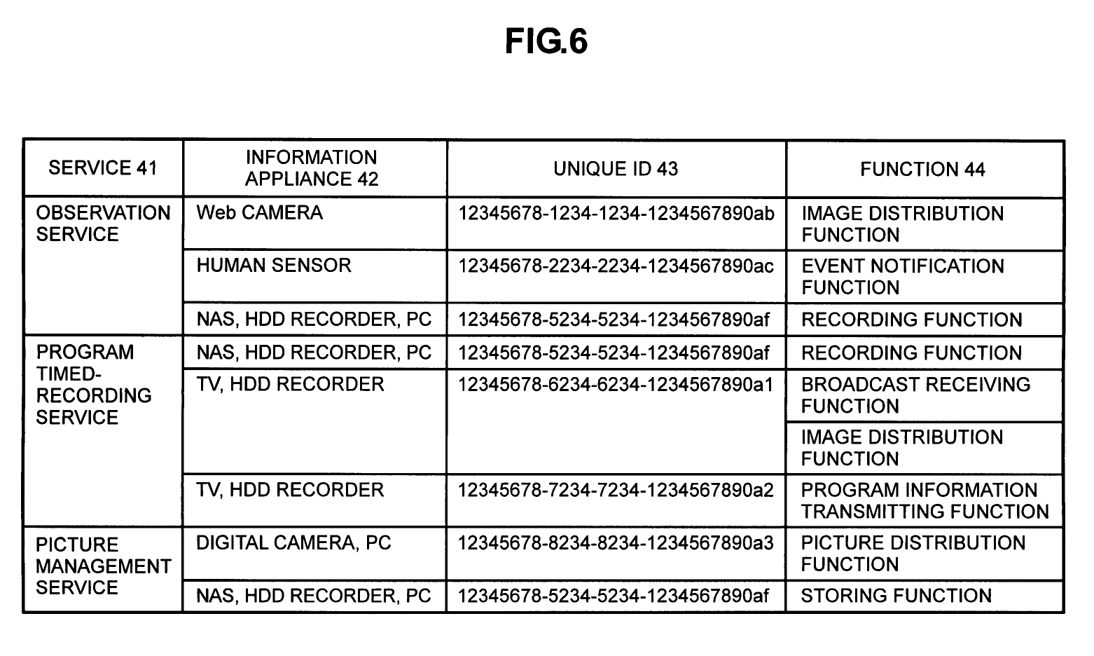

The device management table 40 is a table to be constructed upon basis of the device configuration table 20. If there is the information appliance, which is described in the information appliance 22, on the home network 2, a unique ID (i.e., unique ID 43) for identifying the information appliance is obtained from that information appliance, and it is registered onto the device management table 40. The details thereof will be mentioned, later, by referring to FIG. 6.

The Internet 52 is a network, which is constructed with an optical network, a CATV network, a telephone network, etc., and it enables to communicate of data, in accordance with a certain predetermined process between the apparatuses which are connected to the Internet 52.

The router 50 makes connection between the Internet 52 and the home network 2, thereby enabling the communication of data therebetween.

The file server 54, storing or accumulating therein applications, etc., which are necessary for the information appliances on the home network 2, enables to add and/or change the function of the information appliance through the information appliance downloads the application from the file server 54, depending upon the necessity thereof.

The information appliance c 80, storing or accumulating the device configuration table 20 within a storage device mounted therein, such as, a memory or a HDD, for example, detects the information appliance necessary for the service 21 described on the device configuration table 20 through searching for the information appliances on the home network 2, at timing of adding the new information appliance or the information appliance c 80 onto the home network 2, and thereby producing the device management table 40.

The device management table 40 produced may be stored or accumulated within the memory or the HDD loaded on the information appliance c 80, or may be stored or accumulated within a memory or a HDD thereof, other than that of the information appliance c 80 on the home network 2.

However, in case of the latter, it is necessary for the device management table 40 to memorize existing URI (Uniform Resource Identifier) into the storage device within the information appliance c 80.

Also, if there is an information appliance having a function for managing the device configuration table 20 owned by other information appliance(s), separating from the information appliance c 80, on the home network 2, the information appliance c 80 installs the device configuration table 20 into the information appliance, which manages the device configuration table 20, thereby enabling to provide the service described on the device configuration table 20 to the user.

The information appliance installed with the device configuration table 20 therein searches for the information appliance located on the home network 2, and produces the device management table 40. The device management table 40 produced may be stored into the memory or the HDD loaded on the information appliance c 80, or may be stored into the memory or the HDD thereof, other than that of the information appliance c 80 on the home network 2.

However, in case of the latter, it is necessary for the device management table 40 to memorize existing URI (Uniform Resource Identifier) into the storage device within the information appliance c 80. The information appliance installing the device configuration table 20 therein may be the home server 100, or by means of the home server 10 may be to managed or controlled the device configuration tables 20, which are provided by the information appliances c 80 on the home network 2, together with in a package.

Also, for the information appliance c 80, it is possible to provide a service for the client, by possessing a process 124 having functions of executing the request informed from the client and returning a result of processing therein, with using a middleware, such as, the UPnP and/or the Jini, etc., through the network.

For the purpose of utilizing the process 124 from the server 100, at first, it is necessary to install an application 110 and/or the client 1116 into the home server 100; however, in case where the information appliance c 80 has an area or region for storing or accumulating the application 110 and the client 116 therein (such as, in a program storage portion 84), the application owned by the information appliance c 80 and/or the software of the client 116 may be installed through accessing to the file server locating outside of the home, when installing the device configuration table 20 into the home server 100.

Also, in case when the information appliance c 80 manages the device configuration table 20 and the device management table 40 of other information appliance, it is assumed that the information appliance has, not only a function of providing the service to the client, but also a function as the client, i.e., controlling the service provided by the other information appliance.

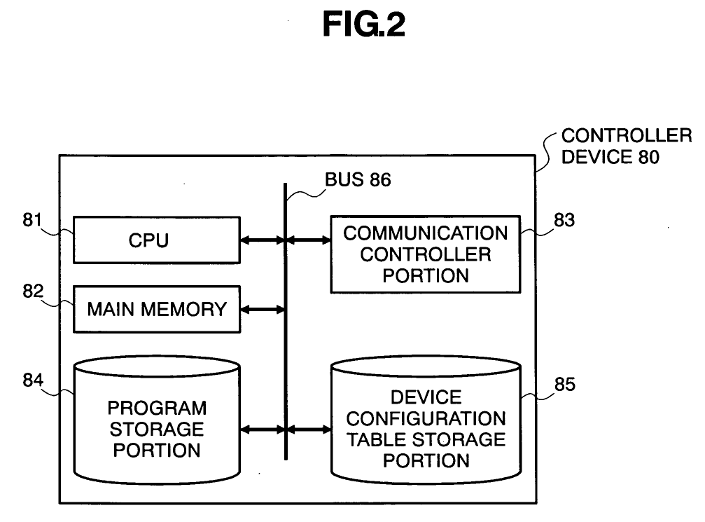

The hardware configuration of the information appliance c 80 will be mentioned, later, by referring to FIG. 2.

Both the information appliance a 60 and the information appliance b 70, installing therein at least the UPnP and/or the Jini, etc., have a function of providing the process 120 and/or the process 122 to the client(s) in the form of a network service. Or, it may has a function similar or equal to that of the information appliance c 80.

The home server 100, installing therein at least the UPnP and/or the Jini, etc., is able to utilize the process 120, the process 122 and/or the 124, which the information appliance c 80 provides, in the form of the network service.

Further, possessing the device configuration table 20, which is transmitted from other information appliance, and the device management table 40, which is produced from the device configuration table 20, enables to achieve service cooperation. In case there is no such the application 110 for controlling a service 41 when utilizing the network service, nor the client for controlling a function 44, as being the service that can be provided through the network, on the home server 100, then a framework, such as, OSGi or the like, is installed, for downloading the client necessary for controlling the information appliance and/or the application 110 for controlling the client, with using the file server 54 provided on the Internet 52, to be utilized thereafter.

Other than utilizing the file server 54, while storing the application 110 necessary for the service 21 and/or the client in the storage device of the information appliance c 80, which newly joins into the home network 2 in advance, the application 110 and/or the client mentioned above may be transmitted from the information appliance c 80 when installing the device configuration table 20 into the home server.

With the home server 100 according to the present embodiment, in case where it is not in the home network 2, it is assumed that an information appliance having the functions of that home server 100 is within the home network 2. Also, for that information appliance, it is not necessary to manage or control the applications 110 in plural numbers thereof by one (1) set of the information appliance, and maybe provided the information appliances in plural number thereof, each being able to manage or control the application 110 and the device configuration table 20 and the device management table 40, wherein each of those may manage or control one (1) or more of the applications 110, respectively.

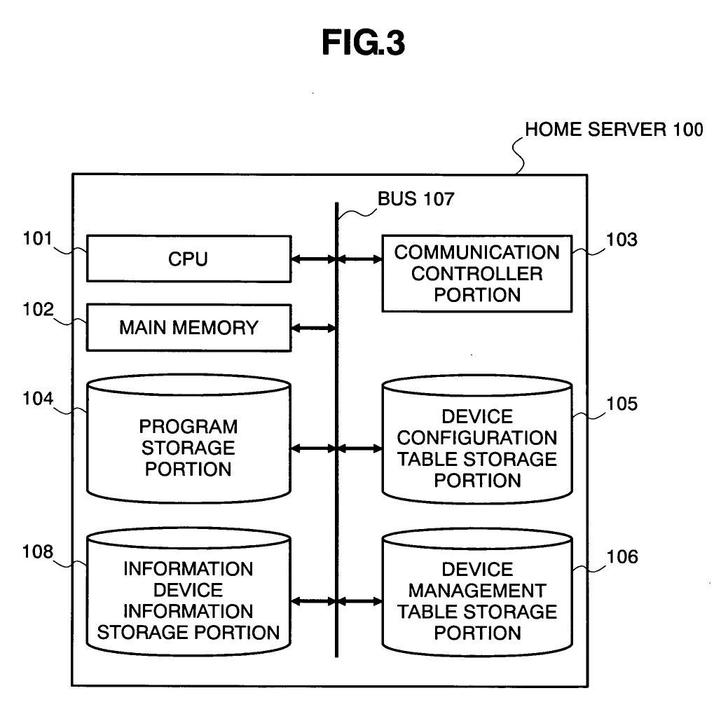

The hardware configuration of the home server 100 will be mentioned later, by referring to FIG. 3, separately.

The application 110 is software for controlling the plural numbers of clients, thereby providing a service for the user. Further, since it is managed or controlled by management software for controlling the service 41, the application 110 can provide a service to the user for the first time when it is registered into the management software.

The management software can make addition/revision/deletion on the application, like a plug-in. The applications 110 registered in the management software are in the same number to that of the services, which are registered in the service 41, and if a service is added into the device management table 40, then the application 110 corresponding to that service is also added into the management software.

The application to be added is downloaded from the program storage portion 84 of the information appliance c 80, which provides the device configuration table 20 necessary for producing the device management table 40, or into the file server 54 outside the home from the storage portion.

Or, if there is no client utilizing the application 110, it is possible to make addition/revision/deletion onto the client, by information that to the management software.

The clients 112, 114 and 116 make installation through the middleware, such as, the UPnP and/or the Jini, etc., and are software for requesting a process to the network service of the processes 120, 122 and 124, which also make installation through the middleware, such as, the UPnP and/or the Jini, etc., in the similar manner. Under the relationship between the client and the process in the present embodiment, for example, within the processes 120, 122 and 124 for providing the same function, it is possible to execute a process request for the processes 120, 122 and 124 by one (1) set of the clients.

However, according to the present embodiment, for easy explanation thereof, it is assumed that the client 112 executes control of the process 120, the client 114 executes control of the process 122, and the client 116 executes control of the process 124, respectively.

Also, explanation will be made on assumption that the middleware for providing the network service is installed through the UPnP. In actual, it does not matter to utilize any kind of protocol, as far as the protocol has functions of automatically detecting the information appliance, which is added to the network, and informing the available service thereof to the information appliance on the home network.

In the service management system 1, according to the present embodiment, there are plural numbers of the information appliances providing different services and the home server 100, within the home network, while installing the clients for making the process request to the process, which is installed into each of the information appliances of providing said the service, into the home server 100, and installing the application 110 for integrally managing the plural numbers of clients, thereby enabling the user to execute an objective process with easy operation, but without consciousness of the individual services.

In case when wishing to watch and listen a TV program recorded on a portable terminal (or mobile phone), for example, the user must conduct the timed recording of the TV program, and further conduct trans-coding on it into a format that can be reproduced by the portable terminal, after completing the recording, thereby transmitting the contents produced into the HDD or the like, which is loaded on the portable terminal.

Although the individual process can be achieved by using the HDD recorder or the PC, or the service of the Internet, etc., however it takes very long time until when the user can watch and listen the TV program on the portable terminal through executing the respective step. Then, defining a higher service for integrally managing the individual service and installing the application to be executed enables to obtain easy operation by the user.

Also, in the service management system 1 according to the present embodiment, while storing or accumulating the device configuration tables 20 into the information appliance c 80, the device configuration tables 20 is transmitted to the home server 100 when the information appliance c 80 newly enters or joins into the home network 2, wherein the home server 100 searches for the information appliance(s) within the home network 2, so as to make estimation on whether the service described on the device configuration table 20 can be provided or not, thereby producing the device management table 40, and downloads the clients for utilizing the service provided by the information appliance and also the application for integrally managing the clients, from the file server outside the home or the information appliance c 80, to be installed therein, if necessary, thereby enabling to provide the higher service, which can be achieved by the cooperation of services, to the user.

When the information appliance c 80 enters into the home network 2, the higher service that can be realized under the present environment of the home network 2 is informed, immediately, to the user, and thereby enabling the user to utilize it.

FIG. 2 is a view for showing the hardware configuration of the information appliance c 80, into which the present embodiment can be applied.

As is shown in FIG. 2, the information appliance c 80 comprises a CPU 81, a main memory 82, a communication controller portion 83, a program storage portion 84m and a device configuration table storage portion 85. And, each of the constituent elements of the information appliance c 80 is connected through a bus 86, so that necessary information can be transmitted among those constituent elements.

The CPU 81 performs predetermined operations in accordance with programs, which are stored into the main memory and/or the program storage portion 84 in advance.

The main memory 82 builds up a means for functioning as a work area and also for storing the necessary programs therein, and for the former, it can be achieved by a RAM (Random Access Memory), and for the latter, it can be achieved by a ROM (Read Only Memory), etc.

The communication controller apparatus 83 builds up a means for transmitting data between the apparatuses, which are connected to the home network 2, through the home network 2, in the similar manner, and it can be achieved by, for example, a modem, a network adopter, a wireless transmitting apparatus, etc.

The program storage portion 84 builds up a means for reserving therein the program for controlling the operations of the information appliance c 80, and it can be realized by, for example, a HDD (Hard Disk Drive), an optical disk, a Flash memory or the like.

The device configuration table storage portion 85 builds up a means for reserving the device configuration tables 20 describing the services thereon, each having the information appliance c 80 as the constituent element, and it can be achieved by, for example, the HDD, the optical disk, the Flash memory or the like.

In case when managing the application 110 by means of the information appliance c 80, the device management table storage portion (not shown in the figure) and the information appliance information storage portion (not shown in the figure) are necessary, separately, other than the functions mentioned above, and further in the program storage portion are stored the applications 110.

FIG. 3 is a view for showing the hardware configuration of the home server, into which the present embodiment can be applied. As is shown in FIG. 3, the home server 100 comprises a CPU 101, a main memory 102, a communication controller portion 103, a program storage portion 104, a device configuration table storage portion 105 and a device management table storage portion 106. And, each of the constituent elements of the home server 100 is connected through a bus 106, so that necessary information can be transmitted among those constituent elements.

The CPU 101 performs predetermined operations in accordance with programs, which are stored into the main memory and/or the program storage portion 104 in advance.

The main memory 102 builds up a means for functioning as a work area and also for storing the necessary programs therein, and for the former, it can be achieved by a RAM (Random Access Memory), and for the latter, it can be achieved by a ROM (Read Only Memory), etc.

The communication controller apparatus 103 builds up a means for transmitting data between the apparatuses, which are connected to the home network 2, through the home network 2, in the similar manner, and it can be achieved by, for example, a modem, a network adopter, a wireless transmitting apparatus, etc.

The program storage portion 104 builds up a means for reserving therein the program for controlling the operations of the home server 100, and it can be realized by, for example, the HDD, the optical disk, the Flash memory or the like.

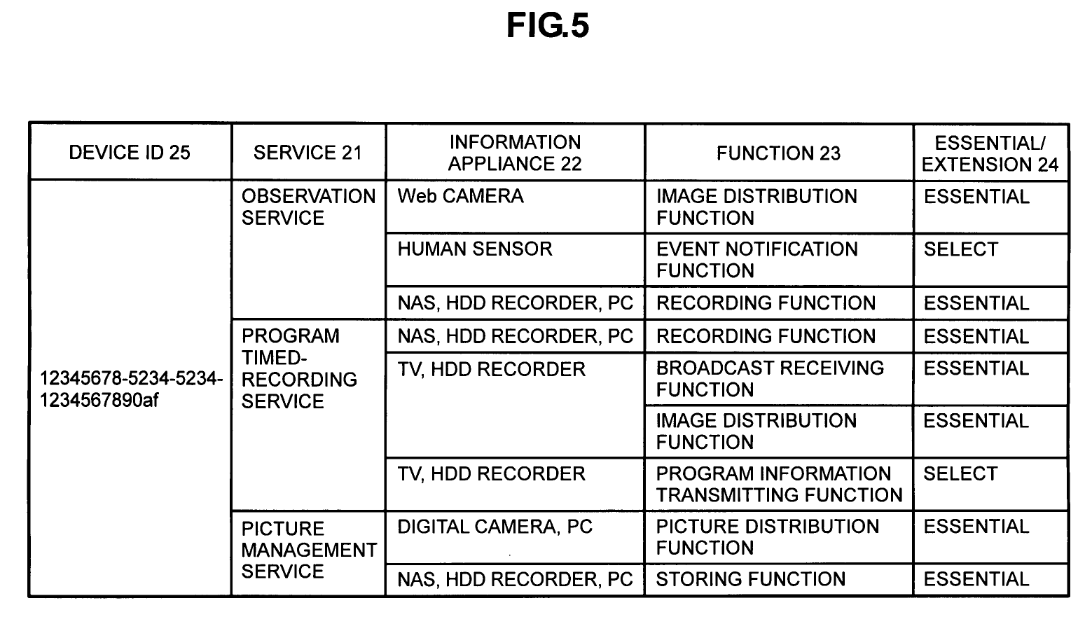

The device configuration table storage portion 105 builds up a means for reserving the device configuration tables 20 thereon, and it can be achieved by, for example, the HDD, the optical disk, the Flash memory, or the like. The device configuration table 20 installed by the information appliance c 80 is managed for each of the information appliances c 80. The device configuration table 20 for each the information appliance is registered, for example, by using the unique ID of the information appliance (FIG. 5: the device configuration table 20 after registration into the device configuration table storage portion 105).

The device management table storage portion 106 builds up a means for reserving the device management tables 40 therein, and it can be achieved by the HDD, the optical disk, the Flash memory or the like. The information device information storage portion 107 builds up a means for reserving the information device information tables 30 therein, each being constructed with a name of the information appliance 31 and the unique ID 32, both building up the home network 2, and it can be realized by, for example, the HDD, the optical disk, the Flash memory or the like.

FIG. 4 shows an example of the structures of the device configuration table 20. This device configuration table 20 comprises services 21 for integrally managing the services, which are provided by the plural numbers of clients and the processes, thereby defining them as the higher services, information appliances 22 necessary for identifying on whether the information appliance locating above the home network 2 is necessary one or not, for the services 21 described on the device configuration table 20, functions 23 to be installed by the information appliance(s) 22, which are necessary for providing the service 21, and flags 24, each indicating that the function 23 is a necessary function, for achieving the service 21, or an extensive function for extending it further.

Further, within the service 21 of the device configuration table 20, the information appliance(s) c 80 necessarily owning the device configuration table(s) 20 therein is/are built up to be the information appliance(s) 22. For the information appliance mentioned above, it is sufficient to discriminate the kind of the information appliance, and any kind of information may be utilized for the discrimination thereof.

FIG. 5 shows an example of the structures of the device configuration/management table 30. This device management table 30 is the device configuration table when it is installed into any one of the information appliances or the home server 100. The device configuration/management table 30 installed is that which is registered by tying the device ID 25 of the information appliance c 80 at an origin of the installation and the device configuration table 20 with a string.

As a way of use thereof, after installing the device configuration table 20, thereby producing such the device management table 40 as is shown in FIG. 6, when further a new information appliance c 80 or the information appliance, which can provide a service installed by the UPnP or the like, enters into the home network 2, newly, search is made for the service 21, which can be provided newly to the user, by searching for the information appliance(s) tied up with the service(s) 21 of the device configuration/management table 30 through a string, by referring to the device configuration/management table 30. When finding out the service 21, which can be provided, the service 21 searched out is registered into the device management table 40, and information is made to the user that the service is available.

With the process of installing the device configuration table, it is desirable to make the installing with using the UPnP or the like, and in that instance, it is necessary to describe the URT to which the application 110 and/or the client should be downloaded, in Preset URL, etc.

FIG. 6 shows an example of the table for showing the device management table 40. The device management table 40 is constructed with a list of the services 41, which can be provided to the user, a list of the information appliance(s) building up the services, a list of the unique ID 43 of the information appliance(s), and list of the functions, which the information appliance(s) provide(s). When the device configuration table 20 is installed into the information appliance c 80 or the home server 100, then the apparatus being installed therewith makes search for the information within the home network 2 and the functions, which the respective information appliances provide, and from the search result thereof, comparison is made between the information appliances and the functions building up the services, so as to pick up the service(s) available to the user from the list of the services 21, and thereby procuring the device management table 40 to be registered into the device management table storage portion 106.

For the unique ID 43, it is necessary to discriminate the information appliances locating on the home network 2 by means of that ID. In case where the installation is made with the UPnP, for example, it is preferable to use a method of utilizing a UND (Unique Device Name).

In case where there are plural numbers of the information appliances, each having the same function, within the home network 2, the unique ID 43 on the device management table 40 can register plural numbers of the unique IDs therein for the information appliances 42 having the same function, so that it can be utilized by any one of the information appliances. However, in case where there are plural numbers of information appliances having the same function within the home, and the physical portions of them be important with respect to the equipments in cooperation with, such as, a TV and/or speakers, or a temperature sensor and/or an air conditioner, etc., it is difficult to grasp the physical positions or the like of the information appliances within the home, from the position on the network. Therefore, it is necessary to make setup by the user, in case when plural numbers of the information appliances having the same function are found out on the home network 2. For that reason, the management is so conducted that the information appliance can be seen easily, which the user sets up. However, as the method for management, any other method may be applicable therein.

Also, it is possible to make the search for the information appliance(s) within the home network 2, every time when the service is executed, but without utilizing the unique ID 43 of the device management table 40 therein. However, in the case where the physical position of the information appliance is important, for the purpose of convenience to the user, it is preferable to make management at least on the unique ID of the information appliance, which the user sets up.

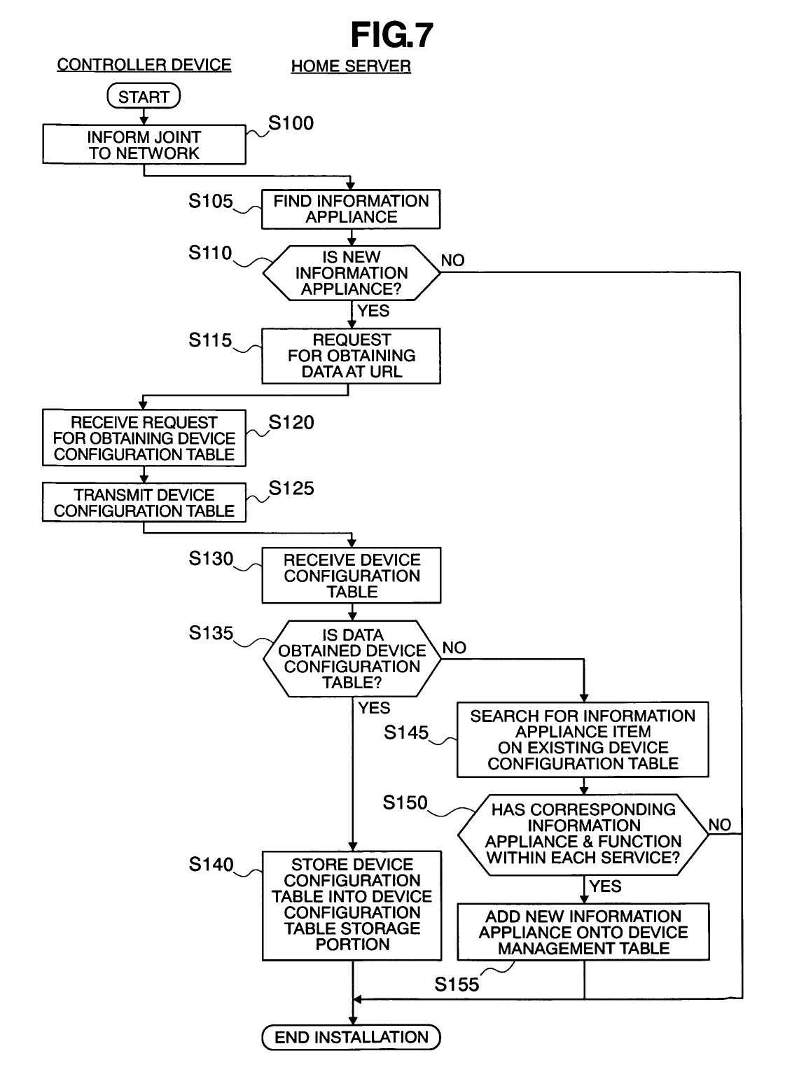

Next, explanation will be made about the operations in the present embodiment, by referring to drawings. FIG. 7 shows a method for registering the device configuration table 20 into the home server 100. In a step S100, the information appliance c 80 makes connection to the home network 2, by using the wireless LAN, the Bluetooth, the UWB, etc., and information is noticed to all of the information appliances and the home server 100 that it enters into. The home server 100 finds out the information appliance c 80 newly added through the notice motioned above, and obtains the device information describing therein the lists of kind and function of the information appliance, the unique ID, and the URL (Uniform Resource Locator), etc., with which the device configuration table 20 can be obtained, in particular, of the new information appliance c 80, thereby obtaining the unique ID 43 (step S105). Searching for the unique ID 32 in the information device information table 30 within the information device information table storage portion 108, confirmation is made on whether there is the information appliance having the same unique ID or not (step S105). In case where no information appliance c 80 is on the table mentioned above, the home server 100 executes a request for obtaining the device configuration table 20 to the information appliance c 80 with utilizing the URL included within the device information (step S115).

Upon receipt of the request for obtaining the device configuration table 20 issued in the step S115 (step S120), the information appliance c 80 transmits the device configuration table 20 owned by the information appliance c 80 (step S125). The home server 100 receives the data transmitted, responding to the obtain request, which is transmitted in the step S115 (step S130).

Determining on whether the data received is the device configuration table 20 or not (step S135), and if it is the device configuration table 20, then that device configuration table 20 obtained is stored or accumulated into the device configuration table storage portion 105, with tying it with the unique ID of the information appliance c 80, which is obtained in advance, by a string (step S140).

In case where the obtained unique ID of the information appliance is on the information device information table 30, in the step S110, then it is determined that the information appliance c 80 was already registered into the home server 100, and then the present registration process is ended.

In case where the obtained data is not the device configuration table 20, in the step S135, then search is made for the information appliance 22 on the device configuration table 20 with using the kind of the information appliance obtained in the step S105, as a search key (step S145).

In case where there is no information appliance corresponding thereto in the step S145, or when there is the corresponding information appliance, but judging from the list obtained in the step S105 that there is no function 23 that is requested by the corresponding information appliance, then the present registration process is ended (step S150).

In case where there is the corresponding information appliance in the step S135, and deciding that there is the function 23, which is requested by the corresponding information from the list of the functions obtained in the step S105, search is made for the device management table 40 within the device management table storage portion 106 of the home server 100, with using the service 21, to which the corresponding information appliance belongs, as the search key, and the unique ID obtained in the step S105 is registered into the unique ID 43 of the information appliance 42 corresponding to the above-mentioned information appliance 22 of the corresponding service 41 (step S155). When the registration process is completed, then the present registration is ended (step S150).

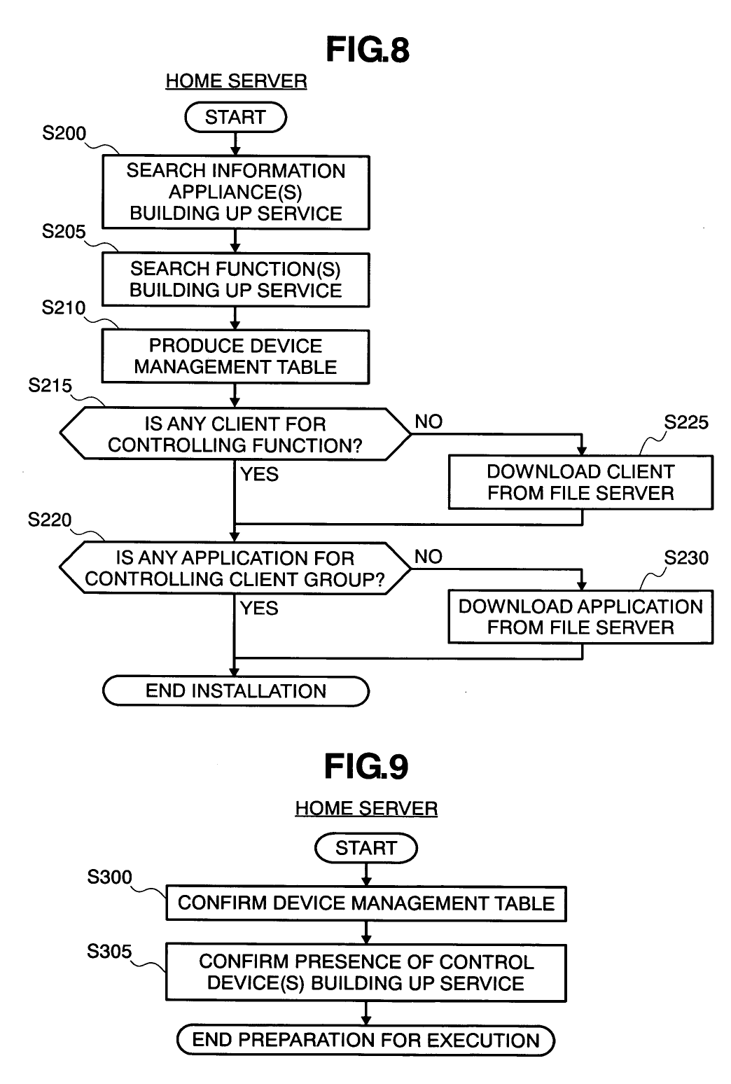

After registering the device configuration server 20 into the home server 100, there is necessity of the client 116 for controlling the information appliance 80 and the application 110 for controlling the plural number of information appliances. In case where the HAVi (Home Audio/Video interoperability) is installed in the information appliance c 80 and the home server 100, and also the client 116 and the application 110 to be executed within the home server 100 are stored or accumulated in the program storage portion 84 of the information appliance c 80, it is possible to install the client 116 and the application 110 into the home server 100, automatically, with utilizing the HAVi middleware, after executing the processes shown in FIG. 7, however according to the present embodiment, explanation will be made about the method for installation with utilizing the OSGi frame work, by referring to FIG. 8.

FIG. 8 is a flowchart for describing the installing method for installing the client 116 necessary for controlling the function 124 of the control device 80 and installing the application 110 for controlling the client 116. After completing the installation of the device configuration table 20, the home server 100 conducts search for all of the information appliances building up the home network 2, by referring to the device configuration table 20 installed in FIG. 7.

In case of utilizing the UPnP, since it is possible to obtain the information appliance information through execution of device description, then search is made on whether the kind of the information appliance of the obtained information fits to any one of the information appliances 22 on the device configuration table 20, or not.

The search is executed for all of the information appliances, which are obtained through the device description. As a result of the search, if the information appliance information obtained does not fit to any of the information appliances 22 described on the device configuration table 20, then the present flowchart is ended (step S200).

For the purpose of comparison of the function 23, which is requested by the corresponding information appliance 22, with the information appliance, for which there is found the corresponding information appliance 22 in the step S200, the list is obtained of the functions owned by that information appliance. In case when the above-mentioned function 23 is in the function list obtained, the process moves to a step S210, on the other hand, there is not, then the present flowchart is ended (step S205).

In case where there is the corresponding information appliance 22 and the function 23 requested by the above-mentioned information appliance 22 within the home network 2 in the process of the step S205, and as the result of executing the steps S200 and S205 on all of the information appliances within the home network 2, there is the information appliance, which can provide at least an essential function of the above-mentioned service, then the above-mentioned service 21 is added to the device management table 40 of the device management table storage portion 106. The constructing information appliances input UDN of the information appliance to be added into unique ID 43 of the corresponding information appliance 42 of the service 41 which was added (step S210).

At the instance when completing the addition of service onto the device management table 40, it is confirmed on whether there is the software of the client or not, for controlling the processes of the information appliances belonging to the service, which was added to the home server 100. In case when there is no client (step S215), the home server 100 makes access to the file server 54 located on the Internet 52, so as to search for the necessary software, with using the service 41 to be provided, the information appliance 42 to be controlled, and the function 44 to be controlled, as the search key, and thereby downloading it.

Relating to the mechanism for downloading the client software from the file server 54, in case where the OSGi frame work is installed in relation to the home server 100 and the file server 54, the client software may be downloaded with utilizing the function of the OSGi (step S225). Further, in case where there is no application 110 for managing the service 41 within the home server 100 (step S220), access is made to the file server 54 with using the service as the search key, and thereby downloading the corresponding application 110 (step S230).

When completing the download in the step S225 or S230 and thereby completing the installation of the software, then the present flowchart is ended. In case where there is already the software to be downloaded in the step S215 or S220, the downloading process will not be generated (step S215 and step S220).

Next, explanation will be given about a method for executing the application, by referring to FIG. 9 attached. First of all, the application 110 receives an operation made by the user and/or an event notice from the sensor. As the operation made by the user, for example, there can be considered a method of providing the user interface through the HTML (Hyper Text Markup Language) while the server 100 has the Web server function, and a method of providing the user interface with utilizing the UPnP from the TV to the home server 100, using the TV on the home network 2, etc.

With using the method of the former, the Web browser must be installed into the terminal for displaying the user interface, and with the latter, a client is needed for controlling the application 110 on the TV side, while for the application 110 is necessary a function for providing the user interface to other terminal through the UPnP.

Upon receipt of the operation made by the user and/or the event notice from the sensor, the application 110 confirms the device management table 40, and thereby finding out which one of the services within the device management table 40, upon basis of the service operated by the user, the content of the event notice, and the information appliance originating the notice therefrom (step S300).

When finding out the service requested by the user or the event, confirmation is made on whether the information appliance belonging to the service is located or not, on the home network 2. When making the confirmation on the information appliance, it is made for the information appliance of the unique ID 43, which is registered onto the device management table 40 (step S305). When confirming that the information appliance can be used, then the service is executed. Herein, when the information appliance cannot be used, then the application 110 verifies on if it is possible or not, to provide only the essential function(s) in the service, and thereby enabling the service to be available by only the information appliance(s), which is/are available when the event is generated.

With contents of the service, although the details thereof not be explained herein, however, if there are provided a Web camera and a HDD recorder or a NAS on the home network 2, as the information appliances in the observation service, for example, it is possible to provide the service of always storing or accumulating the picture at the position where the Web camera is provided into the HDD recorder or the NAS, in cooperation with the application 110 of the home server 100.

Also, herein, further providing an information appliance, such as, a human sensor, for example, in vicinity of a window or a door of a house, enables the application 110 to receive the event notice from the human sensor through the mediation of the application 110, and thereby providing the service of storing or accumulating the picture of the Web camera into the HDD recorder or the NAS by the application 110, only for a predetermined time-period from the time when the event notice is made, with an aid of the Web camera.

Other than the embodiment mentioned above, there can be considered a model, in which no such home server 100 is located on the home network 2. In this case, not such the system of collectively managing by the home server, but the device configuration table, which is owned by each of the information appliances, is managed by the each information appliance, respectively, and also the device management table thereof is managed by itself. Those managements can be achieved where the information appliance owning the device management table has the function same to that of the above-mentioned home server. Regarding the flow of processes, since it is same or similar to that of the home server model, therefore explanation thereof will be omitted herewith.

However, the present invention should not be limited only to the examples of the embodiments mentioned above, and it is of course that it can be modified or changed into various kinds of structures other than that, but without departing from the essentials or gist of the present invention.

In the embodiments mentioned above, as the information appliance are susceptive various kinds of digital home appliances, such as, the HDD recorder, the PC, the PDA, the portable telephone (or the mobile phone), for example, and as the home server is the PC and/or the HDD recorder. In relation to the contents of the processes mentioned herewith, they may be embodied in the form of embodiment of installing them as the middleware for the information appliances listed up in the above, and it is convenient from a viewpoint of designing thereof.

While we have shown and described several embodiments in accordance with our invention, it should be understood that disclosed embodiments are susceptible of changes and modifications without departing from the scope of the invention. Therefore, we don not intend to be bound by the details shown and described herein but intend to cover all such changes and modifications that fall within the ambit of the appended claims.

What is claimed is:

1. An information processing apparatus, enabling to communicate with an external apparatus through a communication network, comprising:
a memory portion, which is configure to memorize information relating to service therein, describing the service provided with said information processing apparatus and said external apparatus as constituent elements thereof; and
an output portion, which is configure to output information relating to said service memorized within said memory portion and identification information for identifying said information processing apparatus, to said external apparatus, when said external apparatus is connected thereto.

2. The information processing apparatus, as described in the claim 1, wherein
said information relating to the service is obtained through said communication network.

3. The information processing apparatus, as described in the claim 1, wherein
said memory portion memorizes therein a predetermined service name, a kind of an apparatus to be used in said service, a function owned by said apparatus, relating them to one another, to be said information relating to the service.

4. The information processing apparatus, as described in the claim 1, wherein
said information relating to the service includes an identification information indicating the function, which said external apparatus provides, to be an essential function or an extensible function.

5. The information processing apparatus, as described in the claim 1, wherein
said information relating to the service is information relating to a service relating to timed recording.

6. The information processing apparatus, as described in the claim 1, further comprising:
a controller portion, which is configured to make such control that said information relating to the service is outputted, after adding or deleting a predetermined information to said information relating to the service, which is memorized in said memory portion.

7. The information processing apparatus, as described in the claim 5, further comprising:
a controller portion, which is configured to make such control that said information relating to the service is outputted, in form of including an identification information for identifying said information processing apparatus within said information relating to the service, which is memorized in said memory portion.

8. The information processing apparatus, as described in the claim 1, wherein
at least one of said external devices is a home server, and further comprises,
a controller portion, which is configured to make such control that said information relating to the service which is memorized in said memory portion and an identification information for identifying said information processing apparatus are outputted to said home server.

9. An information processing apparatus, enabling to communicate with a plural number of external apparatuses through a communication network, comprising:
an input portion, which is configured to input data, including therein data relating to the service provided with said plural number of external apparatuses as constituent elements thereof, and identification data for identifying said external apparatuses, from said external apparatuses through said communication network; and
an output portion, which is configure to output said data from said input portion to said external apparatuses.

10. An information processing system, for a first information processing apparatus, a second information processing apparatus, and a third information processing apparatus to transmit data through a communication network, wherein
said first information processing apparatus comprises a memory portion, which is configured to memorize information therein, relating to service provided with said first information processing apparatus and said second information processing apparatus as constituent elements, and an output portion, which is configured to output the information relating to said service memorized within said memory portion and identification information for identifying said information processing apparatuses to said third information processing apparatus; and further wherein
said third information processing apparatus comprises a product portion, which is configure to produce information relating to the service, newly, with using the information relating to said service outputted from said first information processing apparatus, and an output portion, which is configured to output the information relating to said service produced by said production portion to said first information processing apparatus and said second information processing apparatus.

11. The information processing system, as described in the claim 10, wherein
at least one of said first information processing apparatus and said second information processing apparatus is a data memory portion, which is configure to memorize data therein.
